(19) United States
(12) Patent Application Publication
(10) Pub. No.: US 2021/0165216 A1
(43) Pub. Date: Jun. 3, 2021

(54) CORRECTION OPTICAL MEMBER AND HEAD-MOUNTED DISPLAY

(71) Applicant: SEIKO EPSON CORPORATION, Tokyo (JP)

(72) Inventors: Masayuki TAKAGI, AZUMINO-SHI (JP); Masatoshi YONEKUBO, HARA-MURA SUWA-GUN (JP); Mitsutaka IDE, SHIOJIRI-SHI (JP)

(73) Assignee: SEIKO EPSON CORPORATION, Tokyo (JP)

(21) Appl. No.: 17/105,516

(22) Filed: Nov. 26, 2020

(30) Foreign Application Priority Data
Nov. 29, 2019 (JP) 2019-216442

(51) Int. Cl. G02B 27/01; G02B 5/18; G02B 5/04; F21V 8/00

(52) U.S. Cl. CPC G02B 27/0101; G02B 5/1842; G02B 2027/011; G02B 6/003; G02B 6/005; G02B 5/04

(57) ABSTRACT

In a correction optical member for an HMD, a first optical member and a second optical member are arranged side by side. The first optical member includes a first diffraction grating disposed on a first surface and a second diffraction grating disposed on a second surface that is opposite to the first surface so as to face away from the first diffraction grating. The second optical member includes a third diffraction grating disposed on a third surface that is arranged in an extending direction of the first surface, and a fourth diffraction grating disposed on a fourth surface that is arranged in an extending direction of the second surface.

The present application is based on, and claims priority from JP Application Serial Number 2019-216442, filed Nov. 29, 2019, the disclosure of which is hereby incorporated by reference herein in its entirety.

### BACKGROUND

### 1. Technical Field

The present disclosure relates to a correction optical member incorporated in a head-mounted display that presents a virtual image to an observer, and a head-mounted display including the correction optical member.

### 2. Related Art

As a head-mounted display (hereinafter, it is also referred to as “HMD”), the head-mounted display in which a lens having a prism region for deflecting emitted image light to change the emitting position is arranged in front of an eye, and a center line of a line of sight is adjusted to right or left in the prism region so as to be aligned with the center line of an image (US 2016/0048038 A1).

In an apparatus described in US 2016/0048038 A1, there is no specific disclosure of a structure of the prism region that changes the emitting position of the image light. The apparatus of US 2016/0048038 A1 is based on see-through vision, and the apparatus generates an shift amount corresponding to an eye distance of a user with respect to the image light emitted to an eye side of the user by the prism region disposed in a lens, and allows visual recognition of a precise image corresponding to the eye distance of the user, but it is considered that an external image visually recognized through the entire lens, particularly an external image of a short distance, is distorted in the prism region.

### SUMMARY

A first correction optical member according to an aspect of the present disclosure is a correction optical member of the head-mounted display, wherein a first optical member and a second optical member are arranged side by side, the first optical member includes a first diffraction grating disposed on a first surface and a second diffraction grating disposed on a second surface that is opposite to the first surface so as to face away from the first diffraction grating, and the second optical member includes a third diffraction grating disposed on a third surface that is arranged in an extending direction of the first surface, and a fourth diffraction grating disposed on a fourth surface that is arranged in an extending direction of the second surface.

A second correction optical member according to an aspect of the present disclosure is a correction optical member of the head-mounted display, wherein a first optical member and a second optical member are arranged side by side, in the first optical member, a first wedge prism and a second wedge prism are arranged with an air layer therebetween such that outer flat surfaces are parallel to each other and inclined surfaces are parallel to each other, and in the second optical member, a third wedge prism and a fourth wedge prism are arranged with an air layer therebetween such that outer flat surfaces are parallel to each other and inclined surfaces are parallel to each other.

### BRIEF DESCRIPTION OF THE DRAWINGS

FIG. 1 is a conceptual plan view describing a usage state of an HMD of a first embodiment.

FIG. 2 is a plan view and a front view describing an optical device of the HMD for a left eye.

FIG. 3 is a plan view describing the optical device of the HMD for a right eye.

FIG. 4 is a conceptual enlarged cross-sectional view describing a first optical member in the optical device of the FIG. 2.

FIG. 5 is a conceptual enlarged cross-sectional view describing a second optical member in the optical device of the FIG. 3.

FIG. 6 illustrates a wavelength dependence of a diffraction efficiency by the optical member of an example.

FIG. 7 is a conceptual enlarged cross-sectional view illustrating a modified example of the optical member illustrated in the FIG. 4 and the like.

FIG. 8 illustrates wavelength dependence of diffraction efficiency by the optical member of the example.

FIG. 9 is a conceptual plan cross-sectional view describing a main part of the HMD of a second embodiment.

FIG. 10 is a conceptual plan cross-sectional view describing the main part of the HMD of the second embodiment.

FIG. 11 illustrates how a wedge layer thickness changes when a wedge angle is varied for the example.

FIG. 12 is a conceptual plan cross-sectional view describing a main part of the HMD of a third embodiment.

### DESCRIPTION OF EXEMPLARY EMBODIMENTS

### First Embodiment

Below, with reference to the accompanying drawings, a first embodiment of a head-mounted display and the like according to of the present disclosure will be described.

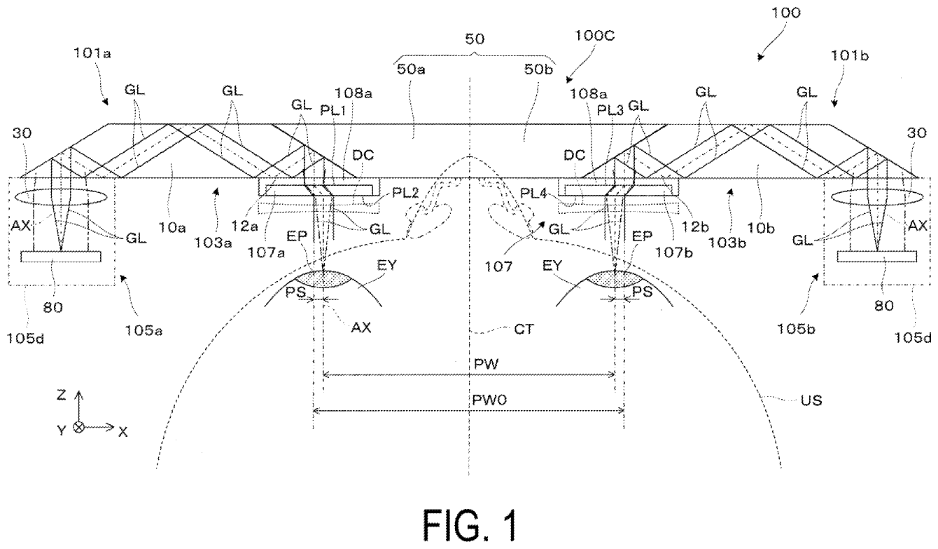

As illustrated in FIG. 1, the head-mounted display (HMD) 100 is a virtual image display device for both eyes having an appearance such as glasses. In FIG. 1 and the like, X, Y, and Z are orthogonal coordinate systems, and a +X direction corresponds to a lateral direction in which two eyes EY of an observer or wearer US wearing the HMD 100 are aligned, that is, a direction from a left eye to a right eye of the wearer US, and a −X direction corresponds to the lateral direction in which the two eyes EY of the wearer US are aligned, that is, a direction from the right eye to the left eye of the wearer US. A +Y direction corresponds to a downward direction perpendicular to the lateral direction of both eyes EY for the wearer US, −Y direction corresponds to an upward direction perpendicular to the lateral direction The +Z direction corresponds to a front or frontal direction for the wearer US.

The HMD 100 is a see-through type HMD or a HMD with a see-through property, and with respect to the observer or wearer US mounted the HMD 100, they can not only visually recognize the virtual image or the display image but also can see through an external image.

The HMD 100 includes a first display device 100A and a second display device 100B. The first display device 101a and the second display device 101b are portions that respectively form a virtual image for the left eye and a virtual image for the right eye. The first display device 101a and the second display device 101b are bilaterally symmetric and have the same configuration.

In the HMD 100, the first display device 101a for a left eye includes a first virtual image forming optical part 103a that perspectively covers front of the eye of the observer, a first image forming body part 105a that forms image light, and a first optical member 107a for pupil interval adjustment. The second display device 101b for a right eye includes a second virtual image forming optical part 103b that perspectively covers front of the eye of the observer, a second image forming body part 105b that forms image light, and a second optical member 107b for pupil interval adjustment. The virtual image forming optical part 103a, 103b includes a light guide formed of a resin material or the like, and the image forming body part 105a, 105b store optical components and electronic components in an outer case 105d. The optical member 107, 107b is a plate-like member and is fixed to the virtual image forming optical part 103a, 103b on the eye EY side or the −Z side. The wearer US looks into the virtual image forming optical part 103a, 103b through both optical members 107a, 107b. A combination of both optical members 107a, 107b is referred to as a correction optical member 107. The correction optical member 107 is fixed with respect to the virtual image forming optical part 103a, 103b, but may also be attachable and detachable with respect to the virtual image forming optical part 103a, 103b. Note that the vision correction lens DC may be disposed on the inner side or the −Z side of the optical member 107, 107b.

The first image forming body part 105a of the first display device 101a for the left eye holds a display element 80 and a projection lens 30 in the outer case 105d, and in addition to these, an electronic circuit board (not shown) and the like are incorporated. The display element 80, projection lens 30, and the like are fixed in a state of being aligned via an attachment member (not shown) in the outer case 105d, in particular, the projection lens 30 is fixed in a state of being aligned with respect to the tip end part of the first virtual image forming optical part 103a. In the first image forming body part 105a for the left eye, the projection lens 30 is arranged in a front stage of an optical path with respect to the first virtual image forming optical part 103a, and constitutes a part of the imaging system.

The second image forming body part 105b of the second display device 101b for the right eye holds the display element 80 and the projection lens 30 in the outer case 105d, and in addition to these, an electronic circuit board (not shown) and the like are incorporated. The projection lens 30, the display element 80, and the like are fixed in a state of being aligned in the outer case 105d, in particular, the projection lens 30 is fixed in a state of being aligned with respect to the tip end part of the second virtual image forming optical part 103b. In the second image forming body part 105b for the right eye, the projection lens 30 is arranged in a front stage of an optical path with respect to the second virtual image forming optical part 103b, and constitutes a part of the imaging system.

The display element 80 incorporated in the first image forming body part 105a is a self-luminous display device that enables two-dimensional display and operates in a dot-matrix manner. The display element 80 is specifically assumed to be a display panel of an organic EL (Electro-luminescence), but the display panel is not limited thereto, and may be a panel for a liquid crystal display (LCD). When a panel for an LCD is used, an appropriate illumination light source is required. The display element 80 is driven by an electronic circuit board (not shown), and forms a color image on a rectangular display surface 81, and can display a two-dimensional moving image or still image. The display element 80 incorporated in the second image forming body part 105b has the same structure as the display element 80 incorporated in the first image forming body part 105a.

The projection lens 30 incorporated in the first image forming body part 105a and the second image forming body part 105b is a collimator, and the image light GL emitted from each point of the image formed in the display element 80 is made into a parallel beam.

The first and second virtual image forming optical parts 103a, 103b form a transparent light-guiding unit 100C that is not a separate body but is a member in which opposite end parts are connected integrally. The transparent light-guiding unit 100C includes a pair of light-guiding devices 10a, 10b that guide image light GL from the display element 80, and a center member 50 that can perform a superimposed view or a see-through view of an external world image. The pair of light-guiding devices 10a, 10b are arranged side by side with respect to the ±X direction in correspondence with the arrangement of the pair of eyes EY. The pair of light-guiding devices 10a, 10b are a pair of optical members that contribute to the formation of a virtual image while propagating the image light GL. The center member 50 has a pair of light transmitting parts 50a, 50b, one light transmitting part 50a is joined to one first light-guiding device 10a, and the other light transmitting part 50b is joined to the other light-guiding device 10b. The transparent light-guiding unit 100C is a composite light-guiding device that provides an image for both eyes EY to the wearer US by light guiding, and both ends that are the tip end of the light-guiding device 10a, 10b are fitted into the outer case 105d, and are supported by the image forming body parts 105a, 105b.

The first optical member 107a is a rectangular flat plate member and is disposed opposed to the first light-guiding device 10a. The first optical member 107a is fixed to the first virtual image forming optical part 103a via a holder 108a, and extends parallel to the emission surface of the light emitting part 12a of the first light-guiding device 10a. The first optical member 107a shifts the image light GL, which is a parallel light beam emitted from the light emitting part 12a of the first virtual image forming optical part 103a, in the lateral +X direction while maintaining the parallel light beam, and in other words, shifting the image light GL toward a center line Cl extending intermediate the eyes EY to enable adjustment of the pupil interval PW. The shift amount PS of the image light GL by the first optical member 107a is fixed, but can be changed by replacing the first optical member 107a.

The second optical member 107b is a rectangular flat plate member and is disposed opposed to the second light-guiding device 10b. The second optical member 107b is fixed to the second virtual image forming optical part 103b via a holder 108b, and extends parallel to the emission surface of the light emitting part 12b of the second light-guiding device 10b. As illustrated in FIG. 1, the second optical member 107b is arranged on the same plane as the first optical member 107a. In other words, the first optical member 107a and the second optical member 107b are in a state of being arranged side by side in the ±X direction corresponding to the arrangement of the pair of eye EY. Here, the state of being arranged side by side is not limited to a case where the center of the first optical member 107a and the center of the second optical member 107b are strictly on the same plane, but also includes the case in which these are arranged so as to be shifted in the optical axis AX direction. The second optical member 107b shifts the image light GL, which is a parallel light beam emitted from the light emitting part 12b of the second virtual image forming optical part 103b, in the lateral −X direction while maintaining the parallel light beam, and in other words, shifting the image light GL toward a center line Cl extending intermediate the eyes EY to enable adjustment of the pupil interval PW. The shift amount PS of the image light GL by the second optical member 107b is fixed, but can be changed by replacing the second optical member 107b.

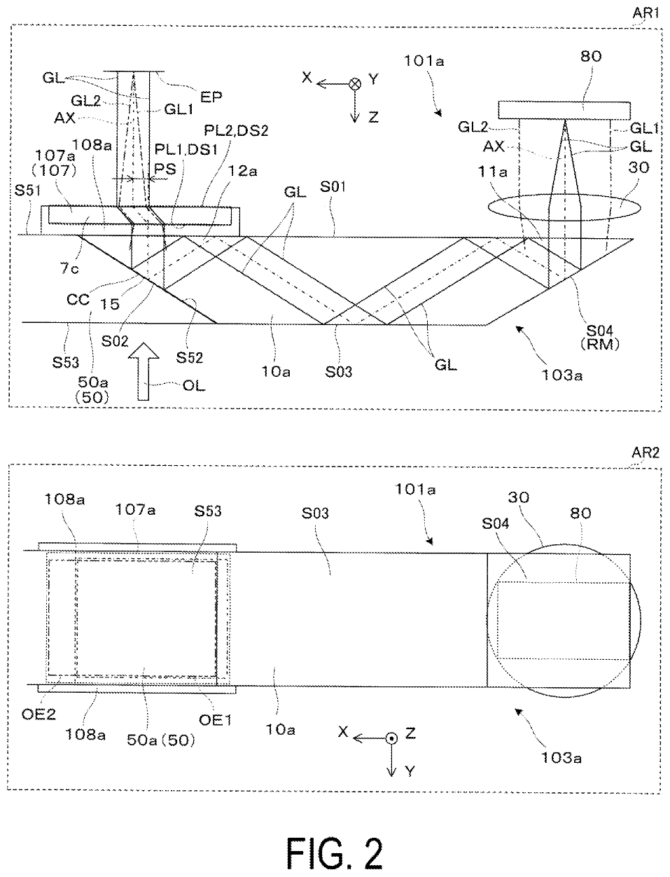

FIG. 2 is a diagram illustrating a first display device 101a, and specifically, describes an optical structure of the first virtual image forming optical part 103a. In FIG. 2, the first region AR1 is a plan view of the first display device 101a, and the second region AR2 is a front view of the first display device 101a.

The first light-guiding device 10a of the first virtual image forming optical part 103a is joined to the light transmitting part 50a via the adhesive layer CC. In other words, the second transmitting surface S52 of the light transmitting part 50a is disposed opposed to the second optical surface S02 of the first light-guiding device 10a, and has the same planar shape. The first light-guiding device 10a and the light transmitting part 50a have a structure in which a surface of the body member that provides a three-dimensional shape including an optical surface is covered with a thin hard coat layer. The body member of the first light-guiding device 10a and the light transmitting part 50a is formed from a resin material having high optical transparency in the visible range, for example, by pouring a thermoplastic resin into a mold and curing the resin.

The first light-guiding device 10a includes a first optical surface S01, a second optical surface S02, a third optical surface S03, and a fourth optical surface S04 from the pupil position EP side. The first optical surface S01 is a surface disposed on the pupil position EP side that is the−Z side and extends parallel to the XY plane, and the third optical surface S03 is a surface disposed on the outside side and extending parallel to the XY plane. In other words, the first optical surface S01 and the third optical surface S03 are arranged parallel to each other. The first optical surface S01 and the third optical surface S03 are total reflection surfaces that reflect the image light GL on the inside. The second optical surface S02 and the fourth optical surface S04 are surfaces arranged in a state of being inclined with respect to the first optical surface S01 and the third optical surface S03. The second optical surface S02 is covered by a half mirror 15 on the outside, and the half mirror 15 partially reflects the image light GL. The half mirror 15 can be constituted by a metal film or a dielectric multilayer film, but is not limited thereto. The fourth optical surface S04 is covered by a reflective film RM and reflects the image light GL inside. The reflective film RM can be constituted by a metal film or a dielectric multilayer film, but is not limited thereto.

The light transmitting part 50a includes a first transmitting surface S51, a second transmitting surface S52, and a third transmitting surface S53. The first transmitting surface S51 is a surface disposed on the pupil position EP side that is the −Z side and extends parallel to the XY plane, and the third transmitting surface S53 is a surface disposed on the outside side and extending parallel to the XY plane. In other words, the first transmitting surface S51 and the third transmitting surface S53 are arranged parallel to each other.

A first optical member 107a includes a body plate 7c which is a parallel plate, a first diffraction grating DS1 disposed on a first surface PL1 of the body plate 7c and a second diffraction grating DS2 disposed on a second surface PL2 of the body plate 7c that is opposite to the first surface PL1, and the second diffraction grating DS2 is configured so as to be outward from each other in a relationship with the first diffraction grating DS1. The first diffraction grating DS1 deflects the image light GL in a predetermined direction inclined in the +X direction and the −Z direction within the XZ plane, and the second diffraction grating DS2 returns the direction of the image light GL deflected by the first diffraction grating DS1 to an original direction. The first diffraction grating DS1 and the second diffraction grating DS2 are blazed diffraction gratings, but may be binary diffraction gratings. A blazed diffraction grating that is a blaze grating allows image light to be emitted with high efficiency in a target direction On the other hand, a binary diffraction grating that is a binary grating can be applied to applications that allow for symmetrical diffraction with respect to positive and negative orders and to increase the width of the light beam. Here, a diffraction angle of first order diffraction light or the like by the first diffraction grating DS1 is equal to the diffraction angle of the first order diffraction light or the like by the second diffraction grating DS2. In order to achieve this, the first diffraction grating DS1 and the second diffraction grating DS2 have the same shape that matches the case when the first diffraction grating DS1 and the second diffraction lattice DS2 are rotated about the axis of symmetry parallel to the Y axis. By equalizing the diffraction angle of the first order diffraction light by the first diffraction grating DS1 and the diffraction angle of the first order diffraction light by the second diffraction grating DS2, the image light GL emitted from the HMD 100 optical system can be efficiently shifted. Air-converted diffraction angles θ of first order diffraction light by the first diffraction grating DS1 and the second diffraction grating DS2 are in a range of 45°<θ<70°. By making the diffraction angle θ larger than 45°, it becomes easy to secure the shift amount. By making the diffraction angle θ smaller than 70°, it is possible to suppress a decrease in the diffraction efficiency and to easily secure the brightness of the image light GL.

The first optical member 107a is arranged so as to cover the angle of view of the image light emitted from the first light-guiding device 10a. Specifically, the first optical member 107a includes an optical effective region OE1 related to the image light of the first light-guiding device 10a, and is disposed in a wider range than this. Furthermore, the first optical member 107a includes an optical effective region OE2 of the light transmitting part 50a and is disposed in a wider range. As a result, even when the image light GL or the optical path is shifted by the first optical member 107a including the diffraction grating as described in more detail below, it is possible to prevent the display image and the external world image from being distorted. The first optical member 107a covers the same view angle range as that of the first light-guiding device 10a with respect to the outside light OL.

Below, the outline of the optical path of the image light GL will be described. The first light-guiding device 10a causes the image light GL to be collimated by the projection lens 30 to be incident via the light incidence part 11a, to be guided by reflection or the like on the first to fourth optical surfaces S01 to S04, and causes the guided image light GL to be emitted to the outside of the eye EY of the wearer US via the light emitting part 12a. Specifically, first the image light GL from the projection lens 30 is incident on a portion of the first optical surface S01 formed in the light incidence part 11a, then passes through the portion, then is reflected by the fourth optical surface S04 is the inner surface of the reflective film RM, and then the image light GL is incident again on the portion of the first optical surface S01 and totally reflected, and then the image light GL is incident on the third optical surface S03 and totally reflected, and then the image light GL is incident on the portion of the first optical surface S01 and totally reflected. The image light GL totally reflected by the first optical surface S01 is incident on the second optical surface S02, is partially reflected while partially passing through the half mirror 15 disposed on the second optical surface S02, and is incident again on the portion of the first optical surface S01 formed in the light emitting part 12a and passes therethrough. The image light GL passing through the first optical surface S01 travels as a whole along the optical axis Ax that is substantially parallel to the Z direction, and is incident as a substantially parallel light beam at the pupil position EP where the eye EY of the wearer US is arranged via the first optical member 107a having a flat plate shape. In other words, the wearer US will observe the image as a virtual image by the image light. Note that the image light GL from the center of the display surface 81 of the display element 80 is indicated by a solid line, and the image light GL1, GL2 from the periphery of the display surface 81 of the display element 80 is indicated by dot-dash lines and two-dot chain lines. The image lights GL1, GL2 show the spread of the angle of view.

The first virtual image forming optical part 103a allows image light to be visual recognized by the first light-guiding device 10a by the wearer US, and allows see-through visibility due to the see-through property thereof. In other words, the first virtual image forming optical part 103a or the first light-guiding device 10a can observe the external world image overlaid on the image or display image. Although the specific structure will be described in detail later, but the first light-guiding device 10a has a transmissivity that allows the outside light OL to traverse while propagating the image light GL, and has an optical surface that suppresses the effect on the image when transmitting the outside light OL. In the case of the present embodiment, the first virtual image forming optical part 103a is configured to allow the wearer US to observe an external world image with little distortion in a state where the first light-guiding device 10a and the light transmitting part 50a are combined. At this time, since the third optical surface S03 and the first optical surface S01 are substantially parallel to each other, a diopter becomes almost 0 for the observation through this portion, and the aberration or the like hardly occurs in the outside light OL. In addition, the third transmitting surface S53 and the first transmitting surface S51 are planes that are substantially parallel to each other, furthermore, the third transmitting surface S53 and the first optical surface S01 are planes that are substantially parallel to each other, thus, almost no aberration or the like occurs. As described above, the wearer US observes the external world image that has no distortion through the light transmitting part 50a.

When viewing the displayed image or the external world image, in the first optical member 107a, the direction of the image light GL deflected by the first diffraction grating DS1 is returned to the original direction by the second diffraction grating DS2. Specifically, for example, the image light GL from the center of the display surface 81 of the display element 80 is parallel to the optical axis Ax via the projection lens 30, propagates in the first light-guiding device 10a in a parallel light bundle state, and the image light GL is emitted from the first light-guiding device 10a, and is shifted from the display element 80 via the first optical member 107a in the +X direction corresponding to the center of the center member 50 by the shift amount PS, and is incident on the pupil position EP as a substantially parallel light beam. The shift amount PS of the image light GL by the first optical member 107a can be arbitrarily set within a predetermined range by the optical characteristics of the first optical member 107a described later. The image light GL is not only emitted as diffraction light via the first optical member 107a, but also passes through the first optical member 107a as non-diffraction light. Accordingly, the diffraction light and the non-diffraction light may be incident on the pupil position EP, but the non-diffraction light may be incident outside of the pupil position EP due to the setting of the optical characteristics of the first optical member 107a.

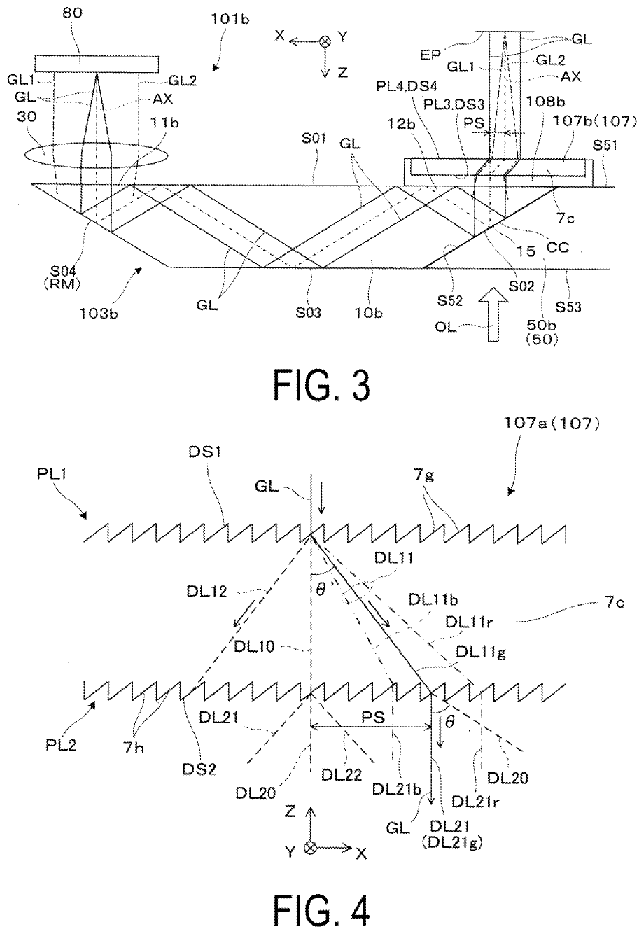

FIG. 3 is a diagram illustrating a second display device 101b, and specifically, describes an optical structure of the first virtual image forming optical part 103b.

The second light-guiding device 10b of the first virtual image forming optical part 103b is joined to the light transmitting part 50b via the adhesive layer CC. In other words, the second transmitting surface S52 of the light transmitting part 50b is disposed opposed to the second optical surface S02 of the second light-guiding device 10b, and has the same planar shape. The second light-guiding device 10b and the light transmitting part 50b have a structure in which a surface of the body member that provides a three-dimensional shape including an optical surface is covered with a thin hard coat layer. The body member of the second light-guiding device 10b and the light transmitting part 50b is formed from a resin material having high optical transparency in the visible range, for example, by pouring a thermoplastic resin into a mold and curing the resin.

The second light-guiding device 10b includes a first optical surface S01, a second optical surface S02, a third optical surface S03, and a fourth optical surface S04 from the pupil position EP side. The first optical surface S01, the second optical surface S02, the third optical surface S03, and the fourth optical surface S04 of the second light-guiding device 10b are formed by inverting the first optical surface S01, the second optical surface S02, the third optical surface S03, and the fourth optical surface S04 of the first light-guiding device 10a illustrated in FIG. 2, thus description thereof is omitted.

The light transmitting part 50a includes a first transmitting surface S51, a second transmitting surface S52, and a third transmitting surface S53. The first transmitting surface S51, the second transmitting surface S52, and the third transmitting surface S53 are formed by inverting the first transmitting surface S51, the second transmitting surface S52, and the third transmitting surface S53 of the light transmitting part 50a illustrated in FIG. 2, thus description thereof is omitted.

A second optical member 107b includes a body plate 7c which is a parallel plate, a first diffraction grating DS3 disposed on a third surface PL3 of the body plate 7c and a fourth diffraction grating DS4 disposed on a fourth surface PL4 of the body plate 7c that is opposite to the third surface PL3, and the fourth diffraction grating DS4 is configured so as to be outward from each other in a relationship with the third diffraction grating DS3. The third surface PL3 and the third diffraction lattice DS3 are arranged in an extension direction of the first surface PL1 of the first optical member 107a illustrated in FIG. 1, and the fourth surface PL4 and the fourth diffraction grating PL3 are arranged in an extension direction of the second surface PL2 of the first optical member 107a illustrated in FIG. 1. Here, the extension direction is not limited to being strictly on the same plane, but includes cases in which they are inclined with respect to each other. The third diffraction grating DS3 deflects the image light GL in a predetermined direction inclined in the −X direction and the −Z direction within the XZ plane, and the fourth diffraction grating DS4 returns the direction of the image light GL deflected by the third diffraction grating DS3 to an original direction. The third diffraction grating DS3 and the fourth diffraction grating DS4 are blazed diffraction gratings, but may be binary diffraction gratings. Here, a diffraction angle of first order diffraction light or the like by the third diffraction grating DS3 is equal to the diffraction angle of the first order diffraction light or the like by the fourth diffraction grating DS4, and is equal to the diffraction angle of the first order diffraction light or the like by the second diffraction grating DS2 and the first diffraction grating DS1 illustrated in FIG. 2. In order to achieve this, the third diffraction grating DS3 and the fourth diffraction grating DS4 have the same shape that matches the case when the third diffraction grating DS3 and the fourth diffraction grating DS4 are rotated about the axis of symmetry parallel to the Y axis, the first diffraction grating DS1 and the second diffraction grating DS2 also have the same shape. By equalizing the diffraction angle of the first order diffraction light by the third diffraction grating DS3 and the diffraction angle of the first order diffraction light by the fourth diffraction grating DS4, the image light GL emitted from the HMD 100 optical system can be efficiently shifted. Air-converted diffraction angles θ of first order diffraction light by the third diffraction grating DS3 and the fourth diffraction grating DS4 are the same as that of the first diffraction grating DS1 and the second diffraction grating DS2, in a range of 45°<θ<70°.

The second optical member 107b is arranged so as to cover the angle of view of the image light emitted from the second light-guiding device 10b. Specifically, the second optical member 107b includes an optical effective region related to the image light of the second light-guiding device 10b or an optical effective region of the light transmitting part 50b, and is disposed in a wider range than this. As a result, even when the image light GL or the optical path is shifted by the second optical member 107b including the diffraction grating as described in more detail below, it is possible to prevent the display image and the external world image from being distorted. The second optical member 107b covers the same view angle range as that of the second light-guiding device 10b with respect to the outside light OL.

Below, the outline of the optical path of the image light GL will be described. The second light-guiding device 10b causes the image light GL to be collimated by the projection lens 30 to be incident via the light incidence part 11b, to be guided by reflection or the like on the first to fourth optical surfaces S01 to S04, and causes the guided image light GL to be emitted to the outside of the eye EY of the wearer US via the light emitting part 12b. The optical path of the image light GL in the second light-guiding device 10b is the same as the optical path of the image light GL reversed right and left in the second light-guiding device 10b illustrated in FIG. 2, and the description thereof is omitted here. Note that the image light GL from the center of the display surface 81 of the display element 80 is indicated by a solid line, and the image light GL1, GL2 from the periphery of the display surface 81 of the display element 80 is indicated by dot-dash lines and two-dot chain lines. The image lights GL1, GL2 show the spread of the angle of view.

The second virtual image forming optical part 103b allows image light to be visual recognized by the second light-guiding device 10b by the wearer US, and allows see-through visibility due to the see-through property thereof. In other words, the second virtual image forming optical part 103b or the second light-guiding device 10b can observe the external world image overlaid on the image or display image. In the case of the present embodiment, the second virtual image forming optical part 103b is configured to allow the wearer US to observe an external world image with little distortion in a state where the second light-guiding device 10b and the light transmitting part 50b are combined. At this time, since the third optical surface S03 and the first optical surface S01 are substantially parallel to each other, a diopter becomes almost 0 for the observation through this portion, and the aberration or the like hardly occurs in the outside light OL. In addition, the third transmitting surface S53 and the first transmitting surface S51 are planes that are substantially parallel to each other, furthermore, the third transmitting surface S53 and the first optical surface S01 are planes that are substantially parallel to each other, thus, almost no aberration or the like occurs. As described above, the wearer US observes the external world image that has no distortion through the light transmitting part 50b.

When viewing the displayed image or the external world image, in the second optical member 107b, the direction of the image light GL deflected by the third diffraction grating DS3 is returned to the original direction by the fourth diffraction grating DS4. Specifically, for example, the image light GL from the center of the display surface 81 of the display element 80 is parallel to the optical axis Ax via the projection lens 30, propagates in the second light-guiding device 10b in a parallel light bundle state, and the image light GL is emitted from the second light-guiding device 10b, and is shifted from the display element 80 via the second optical member 107b in the −X direction corresponding to the center of the center member 50 by the shift amount PS, and is incident on the pupil position EP as a substantially parallel light beam. The shift amount PS of the image light GL by the second optical member 107b can be arbitrarily set within a predetermined range by the optical characteristics of the second optical member 107b described later. The image light GL is not only emitted as diffraction light via the second optical member 107b, but also passes through the second optical member 107b as non-diffraction light. Accordingly, the diffraction light and the non-diffraction light may be incident on the pupil position EP, but the non-diffraction light may be incident outside of the pupil position EP due to the setting of the optical characteristics of the second optical member 107b.

The structure and the light path of the first optical member 107a will be described with reference to FIG. 4. A blaze type first diffraction grating DS1 is formed on the first surface PL1 of the first optical member 107a, and a blaze type second diffraction grating DS2 is formed on the second surface PL2 of the first optical member 107a. The blaze surface 7g of the first diffraction grating DS1 and the blaze surface 7h of the second diffraction grating DS2 is inclined in a direction reversed at the same angle in consideration of the emission direction of diffracted light used in the image light GL. The image light GL incident on the first diffraction grating DS1 of the first surface PL1 of the first optical member 107a is split into the 0th order light DL10, the +1st order light DL11, and the−1st order light DL12. In the above, the +1st order light DL11 includes three beams of diffraction light DL11Rr, DL11Rg, and DL11Rb that have three colors of RGB with different diffraction angles and different inclination angles, but here, basically, a green color (specifically, a wavelength of 550 nm) is used as a design center wavelength, and when there is no particular description, the light rays having a wavelength of 550 nm are used as representative. Note that, for high order diffraction light of the 2nd order or higher, the branching efficiency may be low, and the illustration thereof is omitted. Also, in the case of a blaze type, the branching efficiency of the −1st order light DL12 is also low.

The +1st order light DL11 incident on the second diffraction grating DS2 of the second surface PL2 from the interior of the first optical member 107a is branched into a 0th order light DL20, +1st order light DL21 or the like (for example, diffraction light DL21g). As a result, the +1st order light DL21 traveling in the −Z direction can be extracted as the image light GL passing through the first optical member 107a. The 0th order light DL20 emitted from the second diffraction grating DS2 can be set to be substantially inclined with respect to the +1st order light DL21, and can be set to be incident outside of the pupil position EP. As a result, the image light GL emitted from the first light-guiding device 10a illustrated in FIG. 2 along the optical axis Ax is shifted by the shift amount PS in the +X direction through the first optical member 107a, and is incident on the pupil position EP along the optical axis Ax. Note that, not only the green light having a wavelength of 550 nm but also the red light and the blue light are shifted in the +X direction by an amount corresponding to a wavelength different from the shift amount PS, and incident the pupil position EP along the optical axis AX. The 0th order light DL10, DL20 traveling straight through the second diffraction grating DS2 may be used as the image light GL, but when the diffraction angle of the first order diffracted light becomes equal to or larger than the angle of view of the image light GL and the shift amount PS becomes greater than or equal to a certain degree, it is not incident on the outside of the pupil position EP and will not be observed. That is, it is possible to design a design in which a ghost hardly occurs in the image.

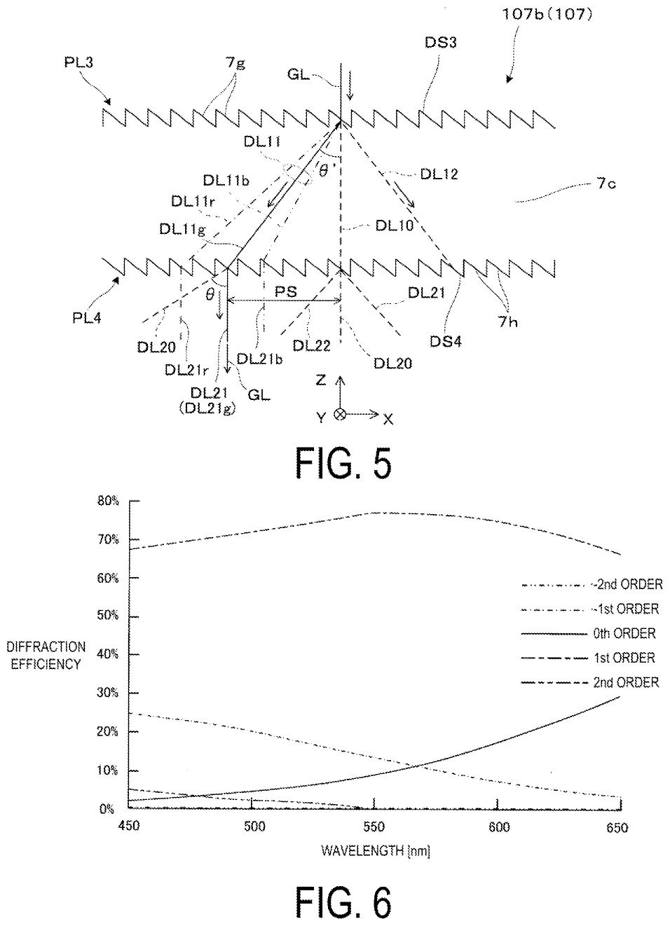

When the first optical member 107a is a blaze type, the efficiency of the first optical member 107a will be different at the ±1st order, and the +1st order light is concentrated and easily collected. As illustrated in FIG. 5 and FIG. 6, since the first diffraction grating DS1 on the incident side and the second diffraction grating DS2 on the emitting side are blaze gratings of the same depth at the same pitch, the light deflected at the time of incidence can be returned to the original, so that the emitting position of light can be changed without distorting the image formed by the image light GL and the outside light OL. Furthermore, the shift amount PS or displacement can be changed by adjusting the thickness of the main body plate 7c, which is the base material regardless of the diffraction gratings DS1 and DS2.

The structure of the second optical member 107b and the light path will be described with reference to FIG. 5. The second optical member 107b illustrated in FIG. 5 has a structure in which the first optical member 107a illustrated in FIG. 4 is inverted with respect to the ±X direction. A third diffraction grating DS3 of a blaze type is formed on the third surface PL3 of the second optical member 107b, and a fourth diffraction grating DS4 of a blaze type is formed on the fourth surface PL4 of the second optical member 107b. The blaze surface 7g of the third diffraction grating DS3 and the blaze surface 7h of the fourth diffraction grating DS4 is inclined in a direction reversed at the same angle in consideration of the emission direction of diffracted light used in the image light GL. The image light GL incident on the third diffraction grating DS3 of the third surface PL3 of the second optical member 107b is split into the 0th order light DL10, the +1st order light DL11, and the −1st order light DL12. In the above, the +1st order light DL11 includes three beams of diffraction light DL11Rr, DL11Rg, and DL11Rb that have three colors of RGB with different diffraction angles and different inclination angles, but here, basically, a green color (specifically, a wavelength of 550 nm) is used as a design center wavelength, and the light rays having a wavelength of 550 nm are used as representative. Note that, for high order diffraction light of the 2nd order or higher, the branching efficiency may be low, and the illustration thereof is omitted. Also, in the case of a blaze type, the branching efficiency of the −1st order light DL12 is also low.

The +1st order light DL11 incident on the fourth diffraction grating DS4 of the fourth surface PL4 from the interior of the second optical member 107b is branched into a 0th order light DL20, +1st order light DL21 or the like (for example, diffraction light DL21g). As a result, the +1st order light DL21 traveling in the −Z direction can be extracted as the image light GL passing through the second optical member 107b. The 0th order light DL20 emitted from the fourth diffraction grating DS4 can be set to be substantially inclined with respect to the +1st order light DL21, and can be set to be incident outside of the pupil position EP. As a result, the image light GL emitted from the second light-guiding device 10b illustrated in FIG. 3 along the optical axis Ax is shifted by the shift amount PS in the −X direction through the second optical member 107b, and is incident on the pupil position EP along the optical axis Ax. Note that, not only the green light having a wavelength of 550 nm but also the red light and the blue light are shifted in the −X direction by an amount corresponding to a wavelength different from the shift amount PS, and incident on the pupil position EP along the optical axis AX. The 0th order light DL10, DL20 traveling straight through the second diffraction grating DS2 may be used as the image light GL, but when the shift amount PS becomes greater than or equal to a certain degree, it is not incident on the outside of the pupil position EP and will not be observed.

Due to the action of the first optical member 107a illustrated in FIG. 4 and the second optical member 107b illustrated in FIG. 5, the pupil interval PW, which is a distance between the pair of image light GL as HMD 100 in the ±X direction, is reduced by an interval 2×PS (see FIG. 1) which is 2 times the respective shift amounts PS, compared to the basic interval PW0 when the optical members 107a and 107b are omitted, in accordance with the pupil position EP of the wearer US. In the above, the shift amount PS of the image light GL caused by the first optical member 107a and the shifting amount PS of the image light GL by the second optical member 107b are equal, but the shift amount of the image light GL by both optical members 107a, 107b may be different. In the above, the pupil interval of a pair of image light GL as HMD 100 is narrowed by both optical members 107a, 107b, but the pupil interval of a pair of image light GL as HMD 100 may be widened by setting the diffraction direction.

In the above, the design center wavelength of the first diffraction grating DS1 and the design center wavelength of the second diffraction grating DS2 are equal to 550 nm, and the design center wavelength of the third diffraction grating DS3 and the design center wavelength of the fourth diffraction grating DS4 are equal to 550 nm. In this case, the characteristics from the first diffraction grating DS1 to the fourth diffraction grating DS4 can be matched, and diffraction near the design can be achieved throughout the entire visible range, and a display image with enhanced left and right symmetry can be provided. Furthermore, the first diffraction grating DS1, the second diffraction grating DS2, the third diffraction grating DS3, and the fourth diffraction grating DS3 have the same shape. In this case, the characteristics of each of the diffraction gratings DS1 to DS4 are completely matched, and the symmetry of the left and right images can be further improved.

Specific examples of the first optical member 107a illustrated in FIG. 4 and the like will be described. The design center wavelength is 550 nm. The pitch of the first to fourth diffraction gratings DS1 to DS4 is 690 nm, and the groove depth is 1.25 μm. The refractive index of the main body plate 7c, which is the base material, is 1.585 (equivalent to polycarbonate), and the thickness of the main body plate 7c is 2 mm. As a result, the diffraction angle θ′ is 30.1° in the main body plate 7c, which is the base material, and θ is 52.6° on the air side after emission. As a result, the shift amount PS of the image light GL depends on the wavelength, but is approximately 0.9 mm˜1.5 mm.

For reference, FIG. 6 illustrates a wavelength dependence of a diffraction efficiency by the optical member 107a, 107b of an example. In the examples, the +1st order light DL11, DL21 is used, and therefore, the efficiency difference between 650 nm and 550 nm is approximately 87%, and the wavelength dependency is considered to be within an acceptable range. In addition, the total efficiency by passing is 77.3×77.3 that is approximately 60% in the case of a wavelength of 550 nm, and the amount of reduced light is also considered to be within an acceptable range.

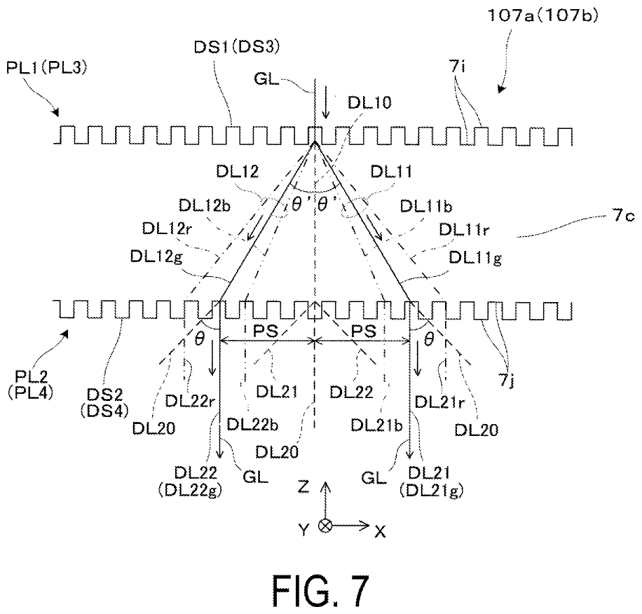

The structure and the light path of the first optical member 107a of modified example will be described with reference to FIG. 7. A binary type first diffraction grating DS1 is formed on the first surface PL1 of the first optical member 107a, and a binary type second diffraction grating DS2 is formed on the second surface PL2 of the first optical member 107a. The binary surface 7i of the first diffraction grating DS1 and the binary surface 7j of the second diffraction lattice DS1 extend parallel to the XY plane. The image light GL incident on the first diffraction grating DS1 of the first surface PL1 of the first optical member 107a is split into the 0th order light DL10, the +1st order light DL11, and the −1st order light DL12. In the above, the +1st order light DL11 includes three beams of diffraction light DL11Rr, DL11Rg, and DL11Rb that have three colors of RGB with different diffraction angles and different inclination angles. Further, the −1st order light DL12 includes three beams of diffraction light DL12Rr, DL12Rg, and DL12Rb that have different inclination angles. Here, basically, a green color (specifically, a wavelength of 550 nm) is used as a design center wavelength, and the light rays having a wavelength of 550 nm are used as representative. Note that, for high order diffraction light of the 2nd order or higher, the branching efficiency may be low, and the illustration thereof is omitted.

Note that the second optical member 107b of the modified example is the same as the first optical member 107b of the modified example, and description thereof is omitted here. By combining the first optical member 107a and the second optical member 107b, the pupil spacing PW of the entire HMD 100 can be expanded in both the increasing and decreasing directions.

The +1st order light DL11 incident on the second diffraction grating DS2 of the second surface PL2 from the interior of the first optical member 107a is branched into a 0th order light DL20, +1st order light DL21 or the like (for example, diffraction light DL21g). As a result, the +1st order light DL21 traveling in the −Z direction can be extracted as the image light GL passing through the first optical member 107a. The 0th order light DL20 emitted from the second diffraction grating DS2 can be set to be substantially inclined with respect to the +1st order light DL21, and can be set to be incident outside of the pupil position EP. As a result, the image light GL emitted from the first light-guiding device 10a along the optical axis Ax is shifted by the shift amount PS in the +X direction through the first optical member 107a, and is incident on the pupil position EP along the optical axis Ax. Note that, not only the green light having a wavelength of 550 nm but also the red light and the blue light are shifted in the +X direction by an shift amount corresponding to a wavelength different from the shift amount PS, and can be incident on the pupil position EP along the optical axis AX.

On the other hand, the −1st order light DL12 incident on the second diffraction grating DS2 of the second surface PL2 from the interior of the first optical member 107a is branched into a 0th order light DL20, −1st order light DL21 or the like (for example, diffraction light DL21g). As a result, the −1st order light DL22 traveling in the −Z direction can be extracted as the image light GL passing through the first optical member 107a. The 0th order light DL20 emitted from the second diffraction grating DS2 can be set to be substantially inclined with respect to the −1st order light DL22, and can be set to be incident outside of the pupil position EP. As a result, the image light GL emitted from the first light-guiding device 10a along the optical axis Ax is shifted by the shift amount PS in the −X direction through the first optical member 107a, and is incident on the pupil position EP along the optical axis Ax. Note that, not only the green light having a wavelength of 550 nm but also the red light and the blue light are shifted by a shift amount corresponding to a wavelength in the −X direction, and can be incident on the pupil position EP along the optical axis AX.

With respect to the +1st order light DL21 resulting from the +1st order light DL11, the 0th order light DL10, DL20 traveling straight ahead of the first optical member 107a, and the −1st order light DL22 resulting from the −1st order light DL12, all of them may be used as the image light GL, or only a part thereof may be used as the image light GL.

When the first optical member 107a is a binary type, the efficiency of the first optical member 107a will be the same at the ±1st order. As illustrated in FIG. 7, since the first diffraction grating DS1 on the incident side and the second diffraction grating DS2 on the emitting side are binary gratings at the same pitch, the light deflected at the time of incidence can be returned to the original, so that the emitting position of light can be changed without distorting the image light GL and the outside light OL. Furthermore, the shift amount PS or displacement can be changed by adjusting the thickness of the main body plate 7c, which is the base material regardless of the diffraction gratings DS1 and DS2.

Specific examples of the first optical member 107a illustrated in FIG. 7 and the like will be described. The design center wavelength is 550 nm. The pitch of the first to fourth diffraction gratings DS1 to DS4 is 720 nm, the groove depth is 600 nm, and the duty ratio is 50%. The refractive index of the main body plate 7c, which is the base material, is 1.585 (equivalent to polycarbonate), and the thickness of the main body plate 7c is 2 mm. As a result, the diffraction angle θ′ is 28.5° in the main body plate 7c, which is the base material, and θ is 49.8° on the air side after emission. As a result, the shift amount PS of the image light GL depends on the wavelength, but is approximately 0.9 mm˜1.4 mm. As a result, by applying the first to fourth diffraction gratings DS1 to DS4 of the above embodiment to the HMD 100 having an emitting pupil size of 5 mm, the exit pupil size can be increased to about 7 mm.

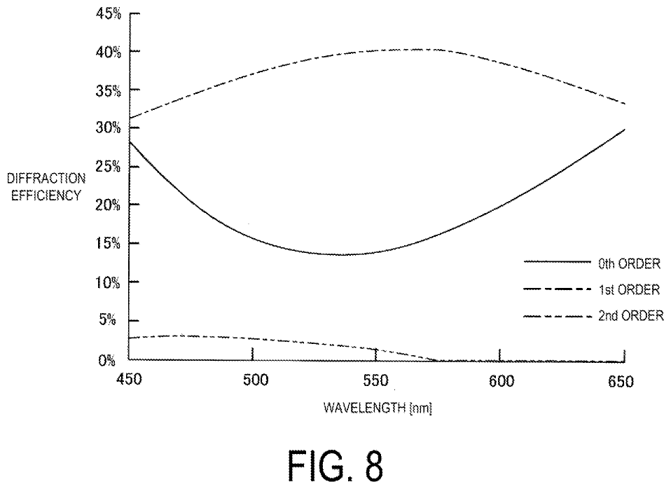

For reference, FIG. 8 illustrates a wavelength dependence of a diffraction efficiency by the optical member 107a, 107b of an example. In the examples, the +1st order light DL11, DL21 is used, and therefore, the efficiency difference between RGB is approximately 77%, and the wavelength dependency is considered to be within an acceptable range. Also, the total passing efficiency is 30˜40% squared.

In the correction optical member 107 of the first embodiment described above, the first optical member 107a having the first diffraction grating DS1 and the second diffraction grating DS2 that face each other and a second optical member 107b having a third diffraction grating DS3 and a fourth diffraction grating DS2 that face each other are arranged side by side, thus, in the first optical member 107a, the light diffracted by the first diffraction grating DS1 can be returned in the original direction by the second diffraction grating DS2, and the light diffracted by the third diffraction grating DS3 in the second optical member 107b can be returned in the original direction by the fourth diffraction grating DS4. By adjusting the characteristics of the diffraction gratings DS1 to DS4 in advance and the spacing between the facing diffraction gratings DS1 to DS4, the spacing that is pupil interval PW between the pair of pupil positions EP configured by the HMD optical system can be increased or decreased via the first optical member 107a and the second optical member 107b of the correction optical member 107.

### Second Embodiment

Below, with reference to the accompanying drawings, a second embodiment of a head-mounted display (HMD) and the like according to of the present disclosure will be described. Note that the HMD of the present embodiment is a modified example of the HMD of the first embodiment, and is the same as the HMD of the first embodiment except for the optical member, and thus the entire illustration and description is omitted.

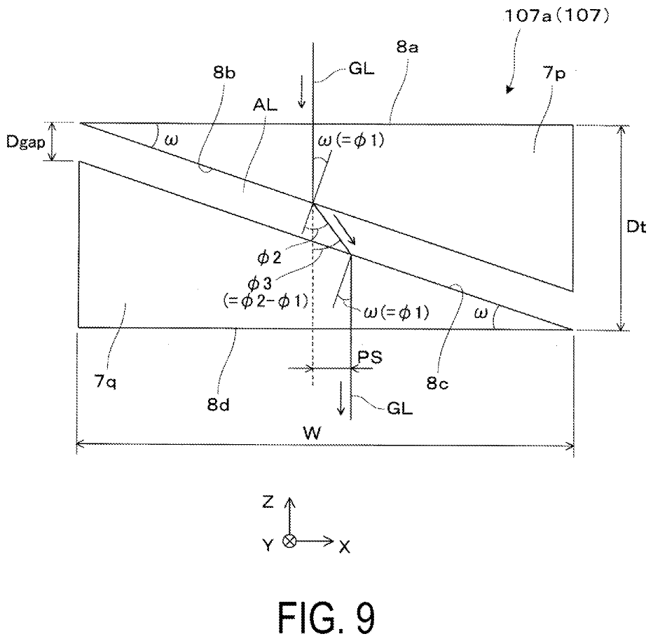

As illustrated in FIG. 9, the first optical member 107a includes a first wedge prism 7p and a second wedge prism 7q rather than a diffraction type. The first wedge prism 7p has an incident surface 8a and an emitting surface 8b, and the second wedge prism 7q has an incident surface 8c and an emitting surface 8d. The incident surface 8a and the emitting surface 8d, which are the outer flat surfaces, are parallel to each other and parallel to the XY plane. The emitting surface 8b and the incident surface 8c, which are inclined surfaces on the inner side, are disposed via the air layer AL so as to be parallel with each other, and are in a state of being inclined with respect to the incident surfaces 8a and 8c.

The image light GL incident on the first wedge prism 7p is refracted by the emitting surface 8b through the incident surface 8a of the first wedge prism 7p, and the incident surface 8c of the second wedge prism 7q is refracted while being emitted from the emitting surface 8d. Since the first wedge prism 7p and the second wedge prism 7q have a symmetrical shape, the image light GL incident on the first wedge prism 7p and the image light GL emitted from the second wedge prism 7q are parallel light traveling in the −Z direction. As a result, the image light GL emitted from the first light-guiding device 10a along the optical axis Ax is shifted by the shift amount PS in the +X direction through the first optical member 107a, and is incident on the pupil position EP along the optical axis Ax. The shift amount PS of the image light GL can be adjusted by the material refractive index, size, wedge angle, spacing, and the like of the first wedge prism 7p and the second wedge prism 7q.

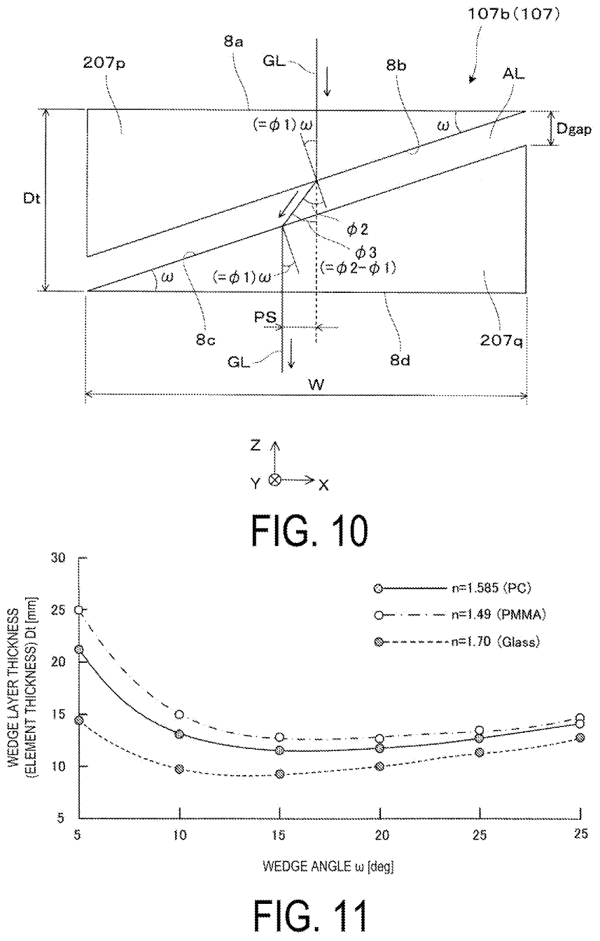

As illustrated in FIG. 10, the second optical member 107b is not a diffraction type, but includes a third wedge prism 207p and a fourth wedge prism 207q. The third wedge prism 207p includes an incident surface 8a and an emitting surface 8b, and the fourth wedge prism 207 q has an incident surface 8c and an emitting surface 8d. The incident surface 8a and the emitting surface 8d are parallel to the XY plane, and the emitting surface 8b and the emitting surface 8d extend parallel to each other via the air layer AL, and are in a state of being inclined with respect to the incident surfaces 8a and 8c. The second optical member 107b is formed by inverting the first optical member 107a illustrated in FIG. 9 in the left-right direction or the X direction.

Since the third wedge prism 207p and the fourth wedge prism 207q have a symmetrical shape, the image light GL incident on the third wedge prism 207p and the image light GL emitted from the fourth wedge prism 207q are parallel light traveling in the −Z direction. As a result, the image light GL emitted from the first light-guiding device 10a along the optical axis Ax is shifted by the shift amount PS in the −X direction through the second optical member 107b, and is incident on the pupil position EP along the optical axis Ax. The shift amount PS of the image light GL can be adjusted by the material refractive index, size, wedge angle, spacing, and the like of the third wedge prism 207p and the fourth wedge prism 207q.

Wedge angles ω of the first wedge prism 7p, the second wedge prism 7q, the third wedge prism 207p, and the fourth wedge prism 207q are in a range of 10°<ω<20°. By making the wedge angle ω to be greater than 10°, a relatively large shift amount PS can be achieved. Additionally, by making the wedge angle ω to be less than 20°, the thickness of the optical members 107a, 107b in the optical axis Ax direction can be reduced.

Due to the action of the first optical member 107a illustrated in FIG. 9 and the second optical member 107b illustrated in FIG. 10, the pupil interval between the pair of image light GL as HMD 100, is reduced by an interval 2×PS which is 2 times the respective shift amounts PS, compared to a case when the optical members 107a and 107b are omitted. In the above, the pupil interval of a pair of image light GL as HMD 100 is narrowed by both optical members 107a, 107b, but the pupil interval of a pair of image light GL as HMD 100 may be widened by setting the deflection direction. Specifically, by inverting the wedge prisms 7p, 7q, 207p, 207q, the image light GL can be shifted in the −X direction by the first optical member 107a, the image light GL can be shifted in the +X direction by the second optical member 107b, and as a result, the optical bundle spacing of the pair of image light GL can be widened, and the pupil interval PW can be changed in a direction that is wider than the base distance PW0. In the above, the first optical member 107a and the second optical member 107b have a left and right inverted structure, but the optical members 107a, 107b may be different from each other in terms of material refractive index, size, wedge angle, spacing, and the like.

Specific examples of the first optical member 107a illustrated in FIG. 9 and the like will be described. When the first optical member 107a applies to HMD 100 having a diagonal angle of view FOV of 50° (horizontal angle of view 44.2°), a pupil diameter of approximately 5 mm and an eye relief of approximately 20 mm is required. In order to obtain a shift amount PS to be 1.0 mm corresponding to the amount of displacement, a refractive index n of the first wedge prism 7p and the second wedge prism 7q is 1.585 (corresponding to polycarbonate), and the wedge angle ω is 15°, the interval Dgap of the first wedge prism 7p and the second wedge prism 7q should be 5.89 mm, and the element width W, which is the width required to swallow all of the image angle of view, needs to be 21.2 mm. Accordingly, the wedge layer thickness Dt is required to be 11.6 mm. In addition, when the refractive index n of the first wedge prism 7p and the second wedge prism 7q is 1.49 (corresponding to PMMA), the wedge angle ω is 20° in order to obtain a shift amount PS to be 1.0 mm corresponding to the displacement amount, the interval Dgap of the first wedge prism 7p and the second wedge prism 7q should be 4.96 mm, and the element width W, which is the width required to swallow all of the image angle of view, needs to be 21.2 mm. Accordingly, the wedge layer thickness Dt is required to be 12.7 mm.

FIG. 11 summarizes how the wedge layer thickness Dt changes when the wedge angle ω is changed. The refractive index n of the wedge prisms 7p and 7q is assumed to be 1.585 corresponding to polycarbonate, 1.49 corresponding to PMMA, and 1.70 corresponding to glass. Although the optimum wedge angle ω for reducing the thickness of the wedge layer is slightly different depending on the refractive index of the wedge prisms 7p and 7q, it can be said that the optimum solution is in the range of 10°<ω<20° in the practical refractive index range.

In the correction optical member 107 of the second embodiment described above, the first optical member 107a having a first wedge prism 7p and a second wedge prism 7q that is arranged to be inverted from each other and the second optical member 107b having the third wedge prism 207p and the fourth wedge prism 207q is arranged to be inverted from each other are arranged side by side, in the first optical member 107a, the light deflected by the first wedge prism 7p can be returned in the original direction by the second wedge prism 7q, and in the second optical member 107b, the light diffracted by the third wedge prism 207p can be returned in the original direction by the fourth wedge prism 207q. By adjusting the characteristics of the wedge prisms 7p, 7q, 207p, 207q and the interval between the opposing wedge prisms 7p, 7q, 207p, 207q in advance, the distance between the pair of pupil positions set by the HMD optical system can be changed or decreased via the first optical member 107a and the second optical member 107b of the correction optical member 107.

### Third Embodiment

Below, with reference to the accompanying drawings, a third embodiment of a head-mounted display (HMD) and the like according to of the present disclosure will be described. Note that the HMD of the present embodiment is a modified example of the HMD of the first embodiment, and is the same as the HMD of the first embodiment except for the light-guiding member.

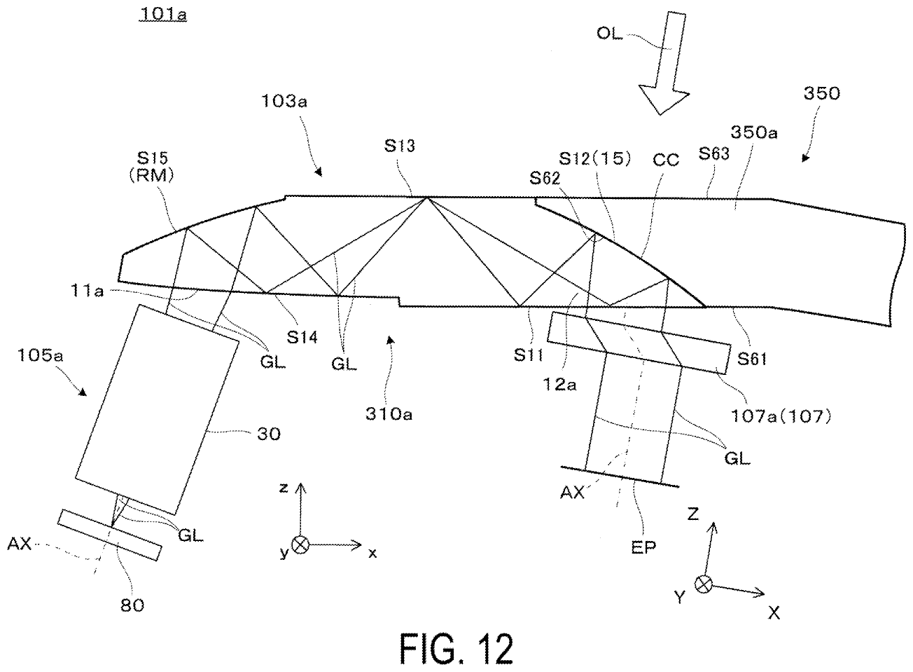

FIG. 12 is a diagram illustrating a part of a first display device 101a, and specifically, describes an optical structure of the first virtual image forming optical part 103a. Although the HMD 100 includes the first display device 101a and the second display device 101b (see FIG. 1 and the like) as described above, since the first display device 101a and the second display device 101b have the same structure in the left-right symmetry, only the first display device 101a will be described, and the description of the first display device 101b will be omitted. Note that in FIG. 12, x, y, and z are orthogonal coordinate systems, and the x direction and y direction are parallel to the first optical surface S11 and the third optical surface S13, and the z direction is perpendicular to the first optical surface S11 and the third optical surface S13. In this first display device 101a, power is applied to a part of the surface constituting the light-guiding device 310a. Additionally, the light-guiding device 310a is disposed inclined with respect to the eye EY of the wearer US.

The light-guiding device 310a of the first virtual image forming optical part 103a is joined to the light transmitting part 350a via the adhesive layer CC. In other words, the second transmitting surface S62 of the light transmitting part 350a is disposed opposed to the second optical surface S12 of the light-guiding device 310a, and has the same curved shape. The light-guiding device 310a and the light transmitting part 50a have a structure in which a surface of the body member that provides a three-dimensional shape including an optical surface is covered with a thin hard coat layer. The body member of the light-guiding device 310a and the light transmitting part 350a is formed from a resin material having high optical transparency in the visible range, for example, by pouring a thermoplastic resin into a mold and curing the resin. A first optical member 107a is arranged facing the light emitting part 12a of the first virtual optical part 103a. The structure illustrated in FIG. 4, FIG. 7, FIG. 9 and the like can be used as the structure of the first optical member 107a. In FIG. 12, the light-guiding device 310a and the light transmitting part 350a are arranged to be inclined, but the first optical member 107a can be disposed parallel to the xy plane in combination with the light-guiding device 310a.

Below, the outline of the optical path of the image light GL will be described. The light-guiding device 310a guides the image light GL emitted from the projection lens 30 toward the eye EY of the wearer US, such as by reflection at the first to fifth optical surfaces S11 to S15. Specifically, first the image light GL from the projection lens 30 is incident on a portion of the fourth optical surface S14 that is a free-form surface formed in the light incidence part 11a, then is reflected by the fifth optical surface S15 that is a free-form surface and that is the inner surface of the reflective film RM, and then the image light GL is incident again on the fourth optical surface S14 from inside and totally reflected, and then the image light GL is incident on the third optical surface S13 that is flat surface and totally reflected, and then the image light GL is incident on the first optical surface S11 that is flat surface and totally reflected. At this time, an intermediate image is formed in the light-guiding device 310a. The image light GL totally reflected by the first optical surface S11 is incident on the second optical surface S12 that is a free-form surface, is partially reflected while partially passing through the half mirror 15 disposed on the second optical surface S12, and is incident again on the portion of the first optical surface S11 formed in the light emitting part 12a and passes through. The image light GL passing through the first optical surface S11 travels as a whole along an optical axis AX substantially parallel to the Z direction, passes through the first optical member 107a, shifts in the −Z direction, and enters a pupil position EP in which the eye EY of the wearer US is disposed as a parallel light beam. In other words, the wearer US observes the image formed by the image light as the virtual image.

The first virtual image forming optical part 103a causes the light-guiding device 310a to visually recognize image light on the wearer US and is configured to allow the wearer US to observe an external world image with little distortion in a state where the first light guide device 310a and the light transmitting part 350a are combined. At this time, since the third optical surface S13 and the first optical surface S11 are substantially parallel to each other, a diopter becomes almost 0 for the observation through this portion, and the aberration or the like hardly occurs in the outside light OL. In addition, the third transmitting surface S63 and the first transmitting surface S61 are planes that are substantially parallel to each other, furthermore, the third transmitting surface S63 and the first optical surface S11 are planes that are substantially parallel to each other, thus, almost no aberration or the like occurs. As described above, the wearer US observes the external world image that has no distortion through the light transmitting part 350a.

### Modified Examples and Other Items

Characteristics such as the shapes and refractive index of the diffraction gratings DS1, DS2, DS3, and DS4 or the wedge prisms 7p, 7q, 207p, and 207q constituting the first optical member 107a and the second optical member 107b described above can be appropriately changed according to the application or the like of the HMD 100.

Although the display element 80 is an organic EL display panel or an LCD panel in the above description, the display element 80 may be a self-luminous display element represented by an LED array, a laser array, a quantum dot light emitting type element, or the like. Further, the display element 80 may be a display using a laser scanner that incorporates a laser light source and a scanner. Note that, a liquid crystal on silicon (LCOS) (LCoS is a registered trademark) technology may be used instead of the LCD panel. Furthermore, the first and second imaginary forming optical units 103a, 103b are not limited to the optical system based on the light guided in the medium, and may include a projection optical system including an optical element such as a lens, a mirror, or the like as an element instead of the light-guiding device 10a, 10b.

In the first optical member 107a, an interval can be adjusted by separating the first diffraction grating DS1 and the second diffraction grating DS1, and in the second optical member 107b, an interval can be adjusted by separating the third diffraction grating DS3 and the fourth diffraction grating DS4. In this case, the interval between the first diffraction grating DS1 and the second diffraction grating DS1 and the interval between the third diffraction grating DS3 and the fourth diffraction grating DS4 can be changed, and the amount of shift PS can be adjusted by increasing or decreasing. Similarly, the interval between the first wedge prism 7p and the second wedge prism 7q can be adjusted in the first optical member 107a, and the interval between the third wedge prism 207p and the fourth wedge prism 207q can be adjusted in the second optical member 107b.

In the description above, although the configuration in which the pair of light guide devices 10a and 10b are joined by a single central member 50 is described, a pair of light transmitting portions 50a and 50b may be individually bonded to the pair of light-guiding devices 10a and 10b to form a pair of separate members. In this case, the first light-guiding device 10a and the first transmitting unit 50a form the first virtual image forming optical part 103a, and the second light-guiding device 10b and the second transmitting unit 50b are second virtual image forming optical part 103b, the first and second imaginary forming optical parts 103a, 103b are separate members that are independent, and these other members are supported while adjusting the relative arrangement relationship in the frame (not shown).

An apparatus according to a specific aspect is a first correction optical member for a head-mounted display (HMD), wherein a first optical member and a second optical member are arranged side by side, the first optical member includes a first diffraction grating disposed on a first surface and a second diffraction grating disposed on a second surface that is opposite to the first surface so as to face away from the first diffraction grating, and the second optical member includes a third diffraction grating disposed on a third surface that is arranged in an extending direction of the first surface, and a fourth diffraction grating disposed on a fourth surface that is arranged in an extending direction of the second surface.

In the correction optical member of the first embodiment described above, the first optical member having the first diffraction grating and the second diffraction grating that face each other and a second optical member having a third diffraction grating and a fourth diffraction grating that face each other are arranged side by side, thus, in the first optical member, the light diffracted by the first diffraction grating can be returned in the original direction by the second diffraction grating, and the light diffracted by the third diffraction grating in the second optical member can be returned in the original direction by the fourth diffraction grating. By adjusting the characteristics of the diffraction gratings in advance and the spacing between the facing diffraction gratings, the interval between the pair of pupil positions configured by the HMD optical system can be increased or decreased via the first optical member and the second optical member of the correction optical member.

In a specific aspect, a direction of light deflected by the first diffraction grating is returned to an original direction by the second diffraction grating, and a direction of the light deflected by the third diffraction grating is returned to an original direction by the fourth diffraction grating.

In another aspect, a diffraction angle of first diffraction light of the first diffraction grating is equal to a diffraction angle of first diffraction light of the second diffraction grating, and a diffraction angle of first diffraction light of the third diffraction grating is equal to a diffraction angle of first diffraction light of the fourth diffraction grating. In this case, a set of image light emitted from the HMD optical system can be efficiently shifted.

Furthermore, in another aspect, the design center wavelength of the first diffraction grating and the design center wavelength of the second diffraction grating are equal to 550 nm, and the design center wavelength of the third diffraction grating and the design center wavelength of the fourth diffraction grating are equal to 550 nm. In this case, the characteristics from the first diffraction grating to the fourth diffraction grating can be matched, and diffraction near the design can be achieved throughout the entire visible range, and an image with enhanced left and right symmetry can be provided.

Furthermore, in another aspect, the first diffraction grating, the second diffraction grating, the third diffraction grating, and the fourth diffraction grating have the same shape. In this case, the symmetry of the left and right images can be further improved.

Furthermore, in another aspect, the first diffraction grating, the second diffraction grating, the third diffraction grating, and the fourth diffraction grating are blazed or binary diffraction gratings. A blazed diffraction grating allows image light to be emitted with high efficiency in a target direction A binary diffraction grating can be applied to the case that allow for symmetrical diffraction with respect to positive and negative orders and to increase the width of the light beam.

Furthermore, in another aspect, air-converted diffraction angles θ of the first diffraction grating, the second diffraction grating, the third diffraction grating, and the fourth diffraction grating are in a range of 45°<θ<70°.

The apparatus in a specific aspect is a second correction optical member for the head-mounted display (HMD), wherein a first optical member and a second optical member are arranged side by side, in the first optical member, a first wedge prism and a second wedge prism are arranged with an air layer therebetween such that outer flat surfaces are parallel to each other and inclined surfaces are parallel to each other, and in the second optical member, a third wedge prism and a fourth wedge prism are arranged with an air layer therebetween such that outer flat surfaces are parallel to each other and inclined surfaces are parallel to each other.

In the second correction optical member 107, the first optical member having a first wedge prism and a second wedge prism that is arranged to be inverted from each other and the second optical member having the third wedge prism and the fourth wedge prism is arranged to be inverted from each other are arranged side by side, in the first optical member, the light deflected by the first wedge prism can be returned in the original direction by the second wedge prism, and in the second optical member, the light diffracted by the third wedge prism can be returned in the original direction by the fourth wedge prism. By adjusting the characteristics of the wedge prisms and the interval between the opposing wedge prisms in advance, the distance between the pair of pupil positions set by the HMD optical system can be changed or decreased via the first optical member and the second optical member of the correction optical member.

In a specific aspect, wedge angles ω of the first wedge prism, the second wedge prism, the third wedge prism, and the fourth wedge prism are in a range of 10°<ω<20°. By making the wedge angle ω to be greater than 10°, a relatively large shift amount can be achieved. Additionally, by making the wedge angle ω to be less than 20°, the thickness of the first optical member and the second optical member in the optical axis direction can be reduced.

A head-mounted display (HMD) according to a specific aspect includes, a first light-guiding device configured to cause image light to be incident via a light incidence part, guide the image light by reflection, and emit the guided image light to outside via a light emitting part, a second light-guiding device arranged side by side with the first light-guiding device corresponding to an arrangement of a pair of eyes, the second light-guiding device configured to cause image light to be incident via a light incidence part, guide the image light by reflection, and emit the guided image light to outside via a light emitting part, and the correction optical member described above, wherein the first optical member is disposed opposed to the first light-guiding device, and the second optical member is disposed opposed to the second light-guiding device.

In the HMD described above, an interval between a pair of pupil positions configured by the first light-guiding device and the second light-guiding device can be adjusted by the first optical portion and the second optical member.

In a specific aspect, the first light-guiding device and the second light-guiding device have the see-through property. In this case, the external world image can be observed in superposition of the image light.

In another aspect, the first optical member and the second optical member cover an angle of view of the first light-guiding device and an angle of view of the second light-guiding device, respectively. In this case, even when using both the diffraction grating and the wedge prism, distortion of the displayed image or the external world image can be prevented.

What is claimed is:

1. A correction optical member of a head-mounted display, wherein
a first optical member and a second optical member are arranged side by side,
the first optical member includes a first diffraction grating disposed at a first surface and a second diffraction grating disposed at a second surface that is opposite to the first surface so as to face away from the first diffraction grating,
and the second optical member includes a third diffraction grating disposed at a third surface that is arranged in an extending direction of the first surface, and a fourth diffraction grating disposed at a fourth surface that is arranged in an extending direction of the second surface.

2. The correction optical member according to claim 1, wherein
a direction of light deflected by the first diffraction grating is returned to an original direction by the second diffraction grating, and a direction of light deflected by the third diffraction grating is returned to an original direction by the fourth diffraction grating.

3. The correction optical member according to claim 1, wherein
a diffraction angle of first order diffraction light by the first diffraction grating is equal to a diffraction angle of first order diffraction light by the second diffraction grating, and a diffraction angle of first order diffraction light by the third diffraction grating is equal to a diffraction angle of first order diffraction light by the fourth diffraction grating.

4. The correction optical member according to claim 3, wherein
a design center wavelength of the first diffraction grating and a design center wavelength of the second diffraction grating are substantially equal to 550 nm, and a design center wavelength of the third diffraction grating and a design center wavelength of the fourth diffraction grating are substantially equal to 550 nm.

5. The correction optical member according to claim 4, wherein
the first diffraction grating, the second diffraction grating, the third diffraction grating, and the fourth diffraction grating have a same shape.

6. The correction optical member according to claim 4, wherein
the first diffraction grating, the second diffraction grating, the third diffraction grating, and the fourth diffraction grating are blazed or binary diffraction gratings.

7. The correction optical member according to claim 1, wherein
air-converted diffraction angles θ of first order diffraction light by the first diffraction grating, the second diffraction grating, the third diffraction grating, and the fourth diffraction grating are in a range of 45°<θ<70°.

8. A correction optical member of a head-mounted display, wherein
a first optical member and a second optical member are arranged side by side,
the first optical member includes a first wedge prism and a second wedge prism arranged with an air layer therebetween such that outer flat surfaces of the first wedge prism and the second wedge prism are parallel to each other and inclined surfaces of the first wedge prism and the second wedge prism are parallel to each other,
and the second optical member includes a third wedge prism and a fourth wedge prism arranged with an air layer therebetween such that outer flat surfaces of the third wedge prism and the fourth wedge prism are parallel to each other and inclined surfaces of the third wedge prism and the fourth wedge prism are parallel to each other.

9. The correction optical member according to claim 8, wherein
wedge angles ω of the first wedge prism, the second wedge prism, the third wedge prism, and the fourth wedge prism are in a range of 10°<ω<20°.

10. A head-mounted display comprising:
a first light-guiding device configured to cause image light to be incident via a light incidence part, guide the image light by reflection, and emit the guided image light to outside via a light emitting part;
a second light-guiding device arranged side by side with the first light-guiding device corresponding to an arrangement of a pair of eyes, the second light-guiding device being configured to cause image light to be incident via a light incidence part, guide the image light by reflection, and emit the guided image light to outside via a light emitting part; and
the correction optical member according to claim 1 in which the first optical member is disposed opposed to the first light-guiding device, and the second optical member is disposed opposed to the second light-guiding device.

11. The head-mounted display according to claim 10, wherein
the first light-guiding device and the second light-guiding device have a see-through property.

12. The head-mounted display according to claim 10, wherein
the first optical member and the second optical member cover an angle of view of the first light-guiding device and an angle of view of the second light-guiding device, respectively.
